(19) United States
(12) Patent Application Publication
(10) Pub. No.: US 2006/0186055 A1
(43) Pub. Date: Aug. 24, 2006

(54) Device for separation of biological components, and method of separation of biological components using the device

(75) Inventors: Masahiro Kusumoto, Tsuruga-shi (JP); Yoshiaki Nishiya, Tsuruga-shi (JP); Mikio Kishimoto, Ibaraki-shi (JP); Nobuhiro Umebayashi, Ibaraki-shi (JP)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignees: Toyo Boseki Kabushiki Kaisha, Osaka-shi (JP); Hitachi Maxell, Ltd.,, Ibaraki-shi (JP)

(21) Appl. No.: 10/564,563

(22) PCT Filed: Jul. 13, 2004
(86) PCT No.: PCT/JP04/10258

§ 371 Date: Feb. 28, 2006

(30) Foreign Application Priority Data
Jul. 16, 2003 (JP) 2003-197937

(51) Int. Cl. C02F 1/48

(52) U.S. Cl. 210/695; 210/222; 210/739

(57) ABSTRACT

The present invention provides a device relating to separation (extraction, purification) of a biological component such as nucleic acid, protein and the like from a liquid sample containing the biological component, and, as a method, a device for separating a biological component, which contains magnetically responsive particles and a chip obtained by adhering a pair of substrates, which contains one or multiple grooves formed on at least one surface thereof, with the groove(s) placed inside, and a method of separating a biological component from a liquid sample, which uses this device, and includes the following steps (a)-(d): (a) a step of holding the device such that the adhesion surface of the pair of substrates is about perpendicular to the horizontal direction, (b) a step of adsorbing the biological component to magnetically responsive particles by contacting the magnetically responsive particles with the liquid sample containing the biological component, (c) a step of separating the magnetically responsive particles containing the biological component adsorbed thereto from the liquid sample, and (d) a step of separating the biological component from the magnetically responsive particles.

### TECHNICAL FIELD

The present invention relates to a device for separating a biological component from a liquid sample containing the object biological component, and a method of separating a biological component using the device.

### BACKGROUND ART

Separation (extraction, purification) of biological components from biological materials (e.g., cell etc.) containing biological components (e.g., nucleic acid, protein etc.) is an important step in the fields of genetic engineering, protein engineering and clinical diagnosis. For example, for an analysis of a gene, it is necessary to extract a nucleic acid (e.g., DNA, RNA) from a biological material (e.g., cell etc. containing the gene). Moreover, for an analysis of a certain protein, it is necessary to separate and purify the protein from a biological material (e.g., cell etc. containing the protein). In DNA/RNA diagnosis for the detection of infected form such as bacterium and virus, moreover, it is necessary to extract a nucleic acid of the bacterium or virus from a biological material (e.g., blood etc.).

In general, biological components (e.g., nucleic acid, protein etc.) contained in a biological material is not present in a free form but present in a shell consisting of cell membrane and cell wall made of protein, lipid and sugar. For separation of biological components from biological materials, therefore, it is necessary to first apply physical disruption by ultrasonication or heat, enzyme treatment with protease, treatment with surfactant or denaturant and the like to free biological components, and then purify the biological components from the disruption by column chromatography using a carrier such as ion exchanger etc., and the like. The techniques therefor are combined according to the kind of biological components, starting materials and/or use and optimized before use (Molecular Cloning: a laboratory manual, 2nd ed. (Cold Spring Harbor Laboratory Press, 1989)).

However, these methods are markedly time-consuming because they include complicated steps (centrifugation and the like). Moreover, biological component samples of nucleic acid, protein and the like separated by these methods contain large amounts of contaminants. The contaminant means non-object protein and the like, which hinders the analyses to follow. To obtain biological components at high purity, purification requiring complicated and long-term operation is necessary after such separation (extraction, purification) operation, which operation is exemplified by ultracentrifugation based on cesium chloride density gradient, dialysis, desalting-concentration utilizing ultrafiltration and the like.

As a convenient method of extracting nucleic acid, a method using silica as a solid phase carrier for nucleic acid bond is known (JP-A-2-289596). This method enables one-step extraction of nucleic acid from a biological material such as bacteria and the like. This method is advantageous in that the extracted nucleic acid can be immediately used for the subsequent analysis. This is because a special desalting-concentration operation is not necessary, since a low concentration buffer such as water, TE buffer and the like is used as an eluent. However, the nucleic acid obtained by elution from silica according to this method has a low concentration and a low yield. Therefore, it can be applied to PCR (Polymerase Chain reaction) and the like on a normal scale, which require a small amount of nucleic acid for the analysis, but otherwise to analyses including Southern hybridization, Northern blot and the like, and a complicated operation of scaling up and concentration thereafter becomes necessary. This method requires a sufficient amount of a solid phase carrier used for binding nucleic acid, for extraction and purification of the nucleic acid. Therefore, realization of a microscale apparatus is difficult. Microscaling of a system capable of automatic performance of such conventional methods is even more difficult. This is because construction of an automatic system requires a large apparatus equipped with a robot arm for a pipetting operation to stir, separate and transfer a nucleic acid-binding carrier.

As a nucleic acid extraction method with enhanced convenience, a nucleic acid isolation method using a magnetic carrier for nucleic acid binding can be mentioned. For example, there is known a method utilizing magnetically responsive particles having a superparamagnetic iron oxide nucleus, which are covered with a polymerizable silane coating with which the nucleic acid can form a covalent bond (JP-A-60-1564). However, this method, too, affords only a small amount of nucleic acid by elution. Therefore, downscaling is difficult by this method.

### DISCLOSURE OF THE INVENTION

If separation (extraction, purification) of a biological component from a biological material can be performed on a microscale, trace amounts of nucleic acid and protein contained in the sample can be analyzed, and such separation method is expected to be applicable to the diagnosis field. To date, however, a device capable of separation (extraction, purification) of a biological component within a limited area has not been developed.

In view of the above situation, the present invention aims at providing a device capable of realizing a series of steps for separating (extracting, purifying) a biological component such as nucleic acid, protein and the like on a microscale from a liquid sample containing the biological component and a method utilizing the same.

The present inventors have first found that each treatment of stirring, separation and transfer can be performed conveniently and economically by using magnetically responsive particles obtained by coating ferromagnetic iron oxide particles with silica, and appropriately applying a magnetic field or an electric field thereon, and highly efficient extraction of nucleic acid can be afforded. They have also found that the efficiency of nucleic acid extraction is strikingly improved by using a chip obtained by adhering a pair of substrates, having one or multiple grooves formed thereon, with the groove(s) placed inside, maintaining the chip such that the adhesion surface of the substrates is about perpendicular to the horizontal plane, and performing nucleic acid extraction using the above-mentioned magnetically responsive particles in a space formed in the substrates. Furthermore, they have noted that nucleic acid has a negative electric charge caused by a phosphate bonded skeleton, and found that application of an electric field to a system containing magnetically responsive particles results in highly efficient release of nucleic acid from the magnetically responsive particles. Based on these findings, downscaling of the extraction and purification step of nucleic acid, which was unavailable by conventional methods, can be achieved, nucleic acid suitable for analysis can be obtained by an economical and simple constitution, and highly sensitive analysis can be performed with an extremely small amount of a liquid sample. Thus, downscaling of the system is easy, and a small total system of nucleic acid analysis, or what is called a micro-TAS (total analysis system) of nucleic acid analysis, can be realized.

Accordingly, the present invention provides the following constitution.

(1) A device for separating a biological component, which comprises magnetically responsive particles and a chip obtained by adhering a pair of substrates, which comprise one or multiple grooves formed on at least one surface thereof, with the groove(s) placed inside.

(2) The device of the above-mentioned (1), wherein the above-mentioned groove forms, within the chip, at least one compartment and a flow passage communicating with the compartment.

(3) The device of the above-mentioned (2), wherein the above-mentioned groove has a protrusion protruding into the compartment.

(4) The device of any of the above-mentioned (1)-(3), wherein the biological component is a nucleic acid.

(5) The device of the above-mentioned (4), wherein the magnetically responsive particles further comprise silica.

(6) A method of separating a biological component from a liquid sample comprising the biological component, which uses a device of any of the above-mentioned (1)-(3), and comprises the following steps (a)-(d):

(a) a step of holding the above-mentioned device such that the adhesion surface of the pair of substrates is about perpendicular to the horizontal direction,

(b) a step of adsorbing the biological component to magnetically responsive particles by contacting the magnetically responsive particles with the liquid sample containing the biological component,

(c) a step of separating the magnetically responsive particles comprising the biological component adsorbed thereto from the liquid sample, and

(d) a step of separating the biological component from the magnetically responsive particles.

(7) The method of the above-mentioned (6), wherein the magnetically responsive particles comprise ferromagnetic particles.

(8) The method of the above-mentioned (6) or (7), wherein the step (c) is performed by moving the magnetically responsive particles by application of a magnetic field.

(9) The method of any of the above-mentioned (6)-(8), wherein the step (d) is performed by dissolving the biological component in a solvent.

(10) The method of any of the above-mentioned (6)-(9), wherein the step (d) comprises a step of separating the biological component from the magnetically responsive particles by applying an electric field.

(11) The method of any of the above-mentioned (6)-(10), wherein at least one of the above-mentioned steps is automatically controlled.

(12) The method of any of the above-mentioned (6)-(11), wherein the biological component is a nucleic acid.

(13) The method of the above-mentioned (12), wherein the magnetically responsive particles further comprise silica.

### BRIEF DESCRIPTION OF THE DRAWINGS

FIG. 1 schematically shows one preferable embodiment of the device for separating a biological component of the present invention.

FIG. 2 schematically shows a chip tray 13, a reagent cartridge 15 and a magnet driving device 19 preferably used for a method of separating a biological component using the device 1 for separating a biological component of the present invention.

FIG. 3 schematically shows a method of separating a biological component using the device 1 for separating a biological component of the present invention.

In each Figure, reference number 1 shows a device for separating a biological component, reference number 2 shows a chip, reference number 3 shows a substrate, reference number 4 shows a groove, reference number 5 shows a compartment and reference number 6 shows a flow passage.

### DETAILED DESCRIPTION OF THE INVENTION

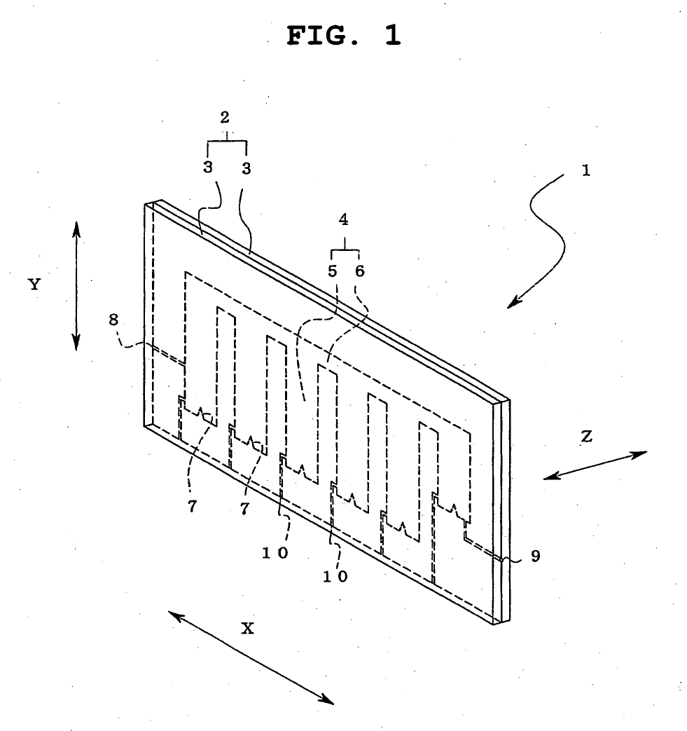

FIG. 1 schematically shows one preferable embodiment of the device 1 for separating a biological component of the present invention. The device 1 for separating a biological component of the present invention is used for separating (extracting, purifying) a biological component from a liquid sample containing the biological component, utilizing magnetically responsive particles. The device 1 for separating a biological component of the present invention comprises a chip 2 obtained by adhering a pair of substrates 3, having one or multiple grooves 4 formed at least on one surface thereof, with the above-mentioned groove(s) placed inside (so that the substrate surface having the groove(s) will not be exposed), and magnetically responsive particles (not shown).

As the “liquid sample containing a biological component” in the present specification, a sample containing DNA, RNA or protein, such as blood, animal cell, plant cell, insect cell, yeast, animal tissue, plant tissue, bacteriophage, virus, bacterium and a combination thereof can be mentioned.

The shape of the main surface of substrate 3 to be used in the present invention is not particularly limited as long as it is a plate, and quadrate (square, rectangle), circle (perfect circle, ellipse), triangle, polygon and the like can be mentioned. Of these, quadrate is preferable from the aspects of easy handling, strength, and easy molding and processing. The size of the substrate 3 is not particularly limited. For downscaling of the system, the size of the substrate 3 is preferably as small as possible within the range where the below-mentioned biological component can be separated. To be specific, the area of the main surface of the substrate 3 is preferably 1 cm²-100 cm², more preferably 5 cm²-40 cm². The chip 2 to be used in the present invention is formed by adhering a pair of substrates 3 with the groove placed inside, as mentioned above. As long as the substrate surface containing the groove is not exposed upon adhesion of the substrates, the respective substrates 3 may have the same size or different sizes. Furthermore, the thickness of the substrate 3 is not limited. In consideration of the fact that the intensity of the agnetic field applied from the outside of the chip as mentioned below depends on the distance from the magnet, the thickness of the substrate 3 is preferably 0.5 mm-5 mm, more preferably 1 mm-2 mm. The respective substrates 3 may have the same thickness or different thicknesses.

Where necessary, the surface of the substrate 3 may be processed for the purpose of, for example, improvement of wetting performance, adjustment of surface tension, prevention of chemical reactions (dissolution, corrosion etc.) of the substrate due to reagents and the like. The method of processing the surface is not particularly limited and can be appropriately selected from conventionally-known methods according to the material of the below-mentioned substrate and the object of processing. As the surface treatment for improving the wetting performance, for example, coating, vapor deposition, sputtering and the like can be mentioned. During these treatments, it is preferable to use a substance having a functional group exhibiting affinity for the reagents used for the separation of biological components.

The material of the substrate 3 is not particularly limited and, for example, thermoplastic resin such as polycarbonate, acrylate, polyolefin and the like; thermosetting resin such as polyimide and the like; glass such as quartz glass, heat resistant glass and the like; semiconductor such as silicon, GaAs and the like; ceramic such as AlN, Al₂O₃ and the like; metal such as CuAl, SUS and the like; fiber made of nylon, polyethylene, polyester and the like; carbon derivative such as carbon, graphite, diamond like carbon, fullerene, carbon nanotube and the like; lumber and the like can be mentioned. As mentioned below, in consideration of the separation of a biological component by applying a magnetic field (and electric field in some cases) from the outside of the chip, easiness of processing (further, easiness of surface treatment in some cases), resistance to reagents such as chaotropic substance and the like (chemical resistance), resistance to temperature during PCR performed in compartments, visibility from the outside and the like, the material of at least one of the substrates 3 is preferably one free of ferromagnetism, such as resin, glass, ceramic, nonmagnetic metal and the like. When an electric field is to be applied in the embodiment of the present invention, resin, glass and ceramic are preferable, because they permit easy increase in the local electric field. The materials of the respective substrates 3 may be the same or different.

In the present invention, one or multiple grooves 4 are formed on at least one of the pair of the substrates forming a chip. When the substrates 3 are adhered to each other such that the groove 4 is placed inside, a space is formed inside the chip 2, and a biological component is separated in the space using magnetically responsive particles. As long as such space is formed inside the chip 2, the shape, size and number of groove 4 per se are not particularly limited. The groove 4 can be formed in the main surface of the substrate by a conventionally-known, appropriate method selected according to the material of the substrate. For example, when the substrate is made of resin, injection molding can be applied, and when the substrate is made of glass, quartz and the like, etching, grinding and the like can be applied.

From the aspect of efficient separation of a biological component, the groove preferably has at least one compartment 5 and a flow passage 6 communicating with the compartment 5.

The compartment 5 is a space used for separation of a biological component from a liquid sample containing the biological component, using magnetically responsive particles, and its size is not particularly limited. When multiple compartments 5 are present, the respective compartments 5 may be of the same size or different sizes. For downscaling, the compartment 5 preferably has a volume of 1 mm³-400 mm³, more preferably 30 mm³-100 mm³. The shape of the compartment 5 is not particularly limited, and may be an appropriate shape such as quadrate (rectangular prism, cube), cylinder, sphere, cone and the like. From the aspects of retention of solution, easy handling, and easy molding or processing, rectangular prism is preferable.

The flow passages 6 only need to be formed to communicate with respective compartments 5. As mentioned below, when a biological component in a liquid sample is separated using the device 1 of the present invention, the adhesion surface of substrates 3 is preferably held to be about perpendicular to the horizontal direction. The flow passages 6 are preferably formed on an end of one side of the compartments 5 to communicate with respective compartments so that the compartments 5 can extend as long as possible in the direction about perpendicular to the horizontal direction when the device 1 is held in this manner. In this case, device 1 is preferably held in such a manner that the end of the compartments 5 communicated with the flow passages 6 becomes the upper side. The width of the above-mentioned flow passage 6 is preferably 5 μm-5 mm, more preferably 50 μm-3 mm, from the aspect of microscaling of the device for separating a biological component. The flow passages 6 may have the same width, or have different widths from each other. The shape of the flow passages 6 is not particularly limited as long as the below-mentioned magnetically responsive particle-biological component composite can move through the flow passages 6, and it may be linear or curved. As shown in FIG. 1, the flow passages 6 are preferably linear.

The depth of the groove 4 is not particularly limited, and can be appropriately determined in consideration of the thickness of the substrates 3. Since the necessary amounts of reagents to be placed in a compartment have been generally determined according to the liquid sample, a smaller depth of the groove requires a larger area of the main surface of the substrate. For downscaling of the whole device, the depth of the groove 4 is preferably 0.1 mm-4.5 mm, more preferably 0.5 mm-1.5 mm. The depth of the groove 4 may be different between compartment 5 and flow passage 6.

The compartment 5 in the present invention may have appropriate concaves and convexes, curved areas or bent areas, as long as the aforementioned space is formed. To achieve efficient stirring of the biological component and magnetically responsive particles, the groove 4 preferably has a protrusion 7 into the compartment 5. When in use, device 1 is preferably held such that the adhesion surface of substrates 3 is about perpendicular to the horizontal direction as mentioned above. Therefore, protrusion 7 is preferably formed on the end opposite to the end communicated with flow passages 6, out of the ends of compartment 5; in other words, on the end that becomes the lower side when device 1 is held as mentioned above.

FIG. 1 shows an embodiment of a device comprising, for example, a chip 2 having a rectangular main surface, wherein multiple (concretely 6) rectangular prism compartments 5, each having the size of about 4 mm (first width)×about 15 mm (second width)×about 1 mm (depth), are arranged along the first width direction X, and respective compartments 5 are communicated with flow passages 6 having a width of 1.5 mm and a depth of 0.8 mm. The flow passages 6 are communicated with the adjacent compartments on one side of respective compartments 5 in the second width direction Y. The device 1 for separating a biological component as shown in FIG. 1 has protrusions 7 for efficiently stirring magnetically responsive particles on the other side of respective compartments 5 in the second width direction Y.

Here, the above-mentioned first width direction X refers to the direction extending generally along the wide side of the four sides forming the rectangular main surface of the chip, and the above-mentioned second width direction Y refers to the direction extending generally along the narrow side of the above-mentioned four sides. The first width direction X, the second width direction Y and the thickness direction Z are perpendicular to each other.

The groove 4 in the device 1 of the present invention is preferably communicate with the space outside chip 2 at an inlet 8 to inject a liquid sample containing a biological component (and magnetically responsive particles in some cases) into chip 2, and a discharge opening 9 to take out, from the chip, the biological component separated from the liquid sample. As mentioned below, respective compartments 5 may be formed in such a manner that they are communicated with reagent inlets 10 to inject reagents necessary for separation of a biological component (see FIG. 1).

The method for adhering substrates 3 is not particularly limited as long as the grooves formed in the substrate 3 are placed inside. For example, known adhesives containing two-component or one-component thermosetting resin, UV curable resin and the like, adhesive such as pressure-sensitive adhesive tape and the like, low melting point metal such as Au—Sn, Sn and the like, ultrasonic welding and the like can be mentioned. Particularly, substrates 3 are preferably adhered with an adhesive, because relatively wide range of materials can be adhered easily, high air tightness is achieved, the cost is low and the like.

Since the object from which a biological component is separated using the device of the present invention is a liquid sample, and since reagents are contained in the compartment as mentioned below, the outer circumference of the adhesion surface of the chip is preferably hermetically sealed. The materials used for hermetical sealing are not particularly limited and, for example, rubber materials such as silicone rubber, acrylic rubber, urethane rubber and the like, fluororesin, asbestos, metal, cement and the like can be mentioned. Of these, rubber materials are preferable, since a liquid can be injected from the outside into the groove in the chip using an injection needle and the like, while preventing liquid leakage and regurgitation, processing is easy and the like.

The device of the present invention may be provided in a product form comprising a reagent in advance in a compartment. In this case, the reagent may be injected into the compartment after hermetically sealing the adhesion surface of the substrates as mentioned above, or the adhesion surface may be hermetically sealed after injecting the reagent into the compartment. For injection of the reagent, the below-mentioned reagent cartridge 15 can be preferably used.

The device for separating a biological component of the present invention comprises magnetically responsive particles in addition to a chip. The magnetically responsive particles may be contained in advance in the chip, or injected into the chip when a liquid sample is injected into the chip. As the magnetically responsive particles to be used in the present invention, any particles conventionally known in the art can be used without any particular limitation, as long as they contain ferromagnetic particles. Here, the “ferromagnetic particle” refers to particles that are magnetically responsive (sensitive to magnetic field), and includes superparamagnetic particles as long as they impart magnetic responsivity when processed into magnetically responsive particles. As used herein, “magnetically responsive” means that the particle is sensitive to the magnetic field, as evidenced by magnetization by a magnetic field, attraction to a magnet and the like, when the outside magnetic field is present.

The ferromagnetic particles are not particularly limited as long as they show the above-mentioned magnetic response, and at least one selected from metal particles of iron, cobalt, nickel and the like, oxide such as iron oxide, chromium dioxide and the like, complex of these oxides, various intermetallic compounds and the like can be used. Of these, granules (ferromagnetic iron oxide particles) obtained by oxidation reaction of metal particles mainly made of iron oxide are preferable, since they have stable quality even when dispersed in various chemicals and are superior in sensitivity to magnetic field. As the ferromagnetic iron oxide particles, conventionally-known various ferromagnetic iron oxide particles can be used. Of these, at least one kind selected from ferrite particles such as magnetite (Fe₃O₄) particles, maghemite (γ-Fe₂O₃) particles, magnetite-maghemite intermediate particles, manganese zinc ferrite (Mn_{1-X}Zn_{X}Fe₂O₄) particles and the like is preferable in view of the superior chemical stability, and magnetite particles are particularly preferable in view of the superior sensitivity to magnetic field due to the high magnetic content thereof. The ferromagnetic iron oxide particles can be manufactured by a conventionally-known method, such as oxidation reaction of particles of Fe(OH)₂ and the like in water.

When nucleic acid is extracted using the device for separating a biological component of the present invention, the magnetically responsive particles used preferably contain the aforementioned ferromagnetic particle and silica. In this case, a silica layer is preferably formed as the outermost layer of magnetically responsive particles, thereby covering the outside of the ferromagnetic particles. In this case, the silica layer may be formed to completely cover the ferromagnetic particles, or expose a part of the ferromagnetic particles to the extent the bondability of nucleic acid and silica is not inhibited. One ferromagnetic particle may be coated with silica to give one magnetically responsive particle, or an agglomerate formed by 2 to 100 ferromagnetic particles may be coated with silica to give one magnetically responsive particle. The silica of magnetically responsive particle includes SiO₂ crystal and other form of silicon oxide, skeleton of diatom consisting of SiO₂ and amorphous silicon oxide.

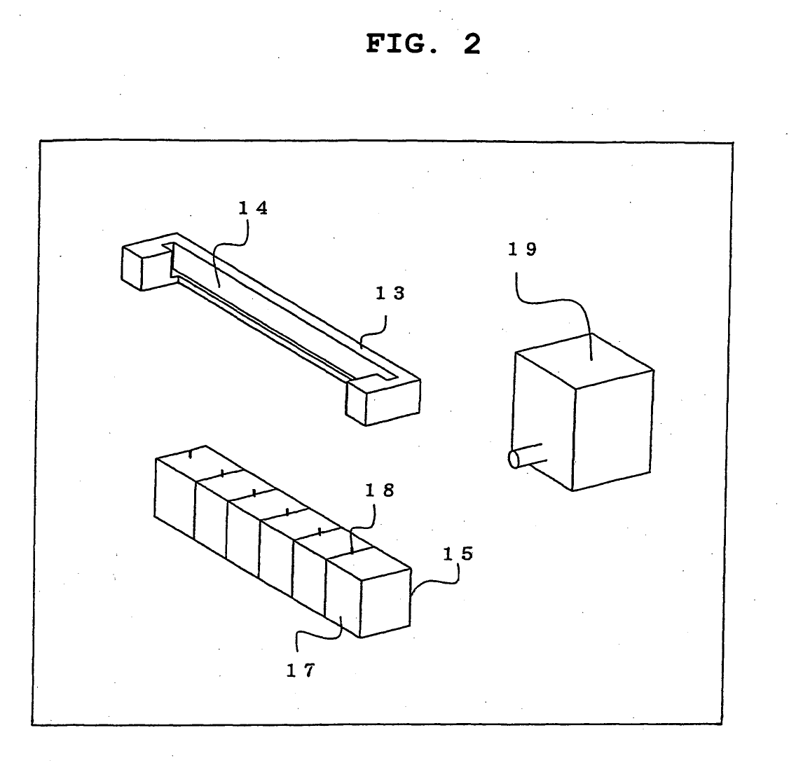

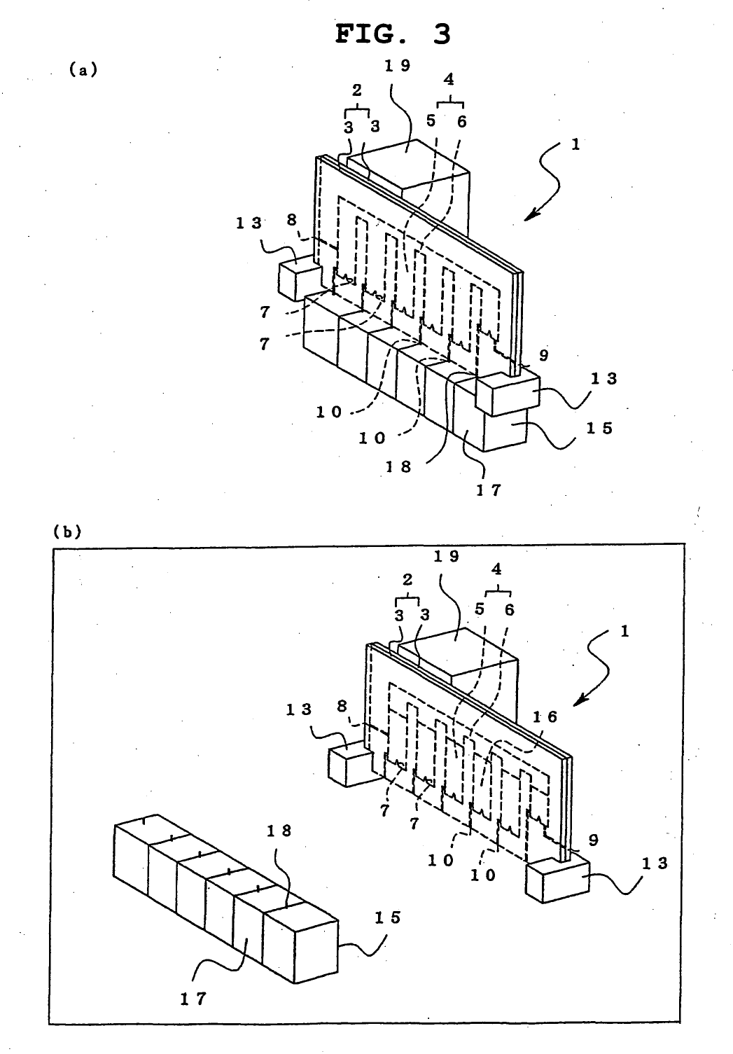

FIG. 2 schematically shows a chip tray 13, a reagent cartridge 15 and a magnet driving device 19 preferably used for a method of separating a biological component from a liquid sample in combination with the device 1 for separating a biological component of the present invention. FIG. 3 schematically shows a method of separating a biological component using the device 1 for separating a biological component of the present invention.

A chip tray 13 is a means preferably used in step (a) of the method of separating a biological component in the present invention mentioned below to hold the device 1 such that the adhesion surface of the substrates is about perpendicular to the horizontal direction. The chip tray 13 has a concave 14 in which to fit, for example, the device 1 shown in FIG. 2 on the upper surface. By inserting device 1 into this concave 14 (FIG. 3 (a)), device 1 can be held such that the adhesion surface of the substrates is about perpendicular to the horizontal direction.

A reagent cartridge 15 is used for supplying various reagents 16 necessary for separating a biological component into compartment 5 in step (b) and step (d) of the method of separating a biological component of the present invention mentioned below. The reagent cartridge 15 has, for example, a reagent feed opening 18 formed to protrude from a cartridge 17. The reagent feed opening 18 is inserted in a reagent inlet 10 of the aforementioned device 1 (FIG. 3 (a)), and then a reagent 16 can be fed into the compartment.

A magnet driving device 19 is a means for providing a magnetic field in step (c) of the method of separating a biological component of the present invention mentioned below. The magnetic field provided by the magnet driving device 19 can energize and move the magnetically responsive particles.

In some cases, power supply to provide electric field, pipetting means, control means and the like can be appropriately combined with the device 1 for separating a biological component of the present invention, during separation of the below-mentioned biological components.

The present invention also provides a method of separating (extracting, purifying) a biological component from a liquid sample containing the biological component, using the aforementioned device 1 for separating a biological component. The method of separating a biological component of the present invention comprises at least the following steps (a)-(d).

(a) a step of holding the device for separating a biological component such that the adhesion surface of the substrates is about perpendicular to the horizontal direction,

(b) a step of adsorbing the biological component to magnetically responsive particles by contacting the magnetically responsive particles with the liquid sample containing the biological component,

(c) a step of separating the magnetically responsive particles comprising the biological component adsorbed thereto from the liquid sample, and

(d) a step of separating the biological component from the magnetically responsive particles.

In step (a) in the method of the present invention, the aforementioned device is held such that the adhesion surface of the substrates is about perpendicular to the horizontal direction to effectively utilize the gravity. In general, when a biological component is separated from a liquid sample containing the biological component, the yield of the object biological component increases as the volume of the liquid sample increases. However, when a compartment having a large area is formed in a thin substrate so as to increase the aforementioned volume, the liquid (liquid sample, reagent and the like) in the compartment spills over from the compartment due to a strong influence of the surface tension, and the function of the device for separating a biological component may be impaired. On the other hand, if the compartment can be made deep, the aforementioned volume can be increased while suppressing the influence of the surface tension to the minimum level. However, formation of a deep groove in a narrow area is difficult to achieve from the aspects of processing and cost, and a deeper compartment to increase the volume results in scaling up of the device. In the present invention, the above-mentioned problems have been solved by holding a device comprising a thin (about 1 mm-2 mm thick) chip having a compartment having a large area, such that the adhesion surface of the substrates is about perpendicular to the horizontal direction, in the above-mentioned step (a). To be specific, for example, compartment 2 shown in FIG. 1 is a rectangular prism of about 1 mm×about 4 mm×about 15 mm, and the groove formed in the substrate to make compartment 2 have a length (first width) in the first width direction X of about 4 mm, a length (second width) in the second width direction Y of about 15 mm, and a length (depth) in the thickness direction Z of about 1 mm. As shown above, the aforementioned volume can be increased economically and easily.

In step (a), a means to hold device 1 such that the adhesion surface of the substrates is about perpendicular to the horizontal direction is not particularly limited, where a preferably means is, for example, the aforementioned chip tray 13 (FIG. 3 (a), (b)).

In step (b) in the method of the present invention, the biological component is made to adsorb to magnetically responsive particles by contacting the magnetically responsive particles with the liquid sample containing the biological component. The conditions for mixing the magnetically responsive particles with the liquid sample to bring the magnetically responsive particles in contact with a biological component in the liquid sample in a reaction vessel are not particularly limited as long as the properties of the biological component and magnetically responsive particles are not impaired. The device 1 for separating a biological component as shown in FIG. 1 is equipped with a protrusion 7 protruding into compartment 5. In the below-mentioned step (c), magnetically responsive particles and protrusion 7 are collided by controlling the magnetic field, whereby the magnetically responsive particles and the liquid sample can be efficiently stirred. At step (b), a liquid sample and magnetically responsive particles are introduced into compartment 5 from an inlet 8 formed in chip 2. When magnetically responsive particles are placed in advance in the chip, only a liquid sample is introduced into compartment 5.

Here, the “adsorption” of a biological component to the magnetically responsive particles means bonding of the two to the extent they can move integrally in the below-mentioned step (c), where the mode of bonding is not limited.

When a nucleic acid in a liquid sample is to be extracted using the device 1 for separating a biological component of the present invention, one comprising ferromagnetic particles and silica as mentioned above is preferably used as the magnetically responsive particle. In consideration of the specific adsorption of nucleic acid to silica, magnetically responsive particles and a liquid sample are preferably mixed in a compartment in the coexistence of a solution for extraction and purification of nucleic acid, which contains at least a chaotropic substance; in other words, in the presence of a chaotropic ion. As the above-mentioned chaotropic substance, at least one kind selected from guanidine salt, sodium iodide, potassium iodide, sodium (iso)thiocyanate, urea and the like can be mentioned. Of these, guanidine-thiocyanate salt is particularly preferable. The concentration of the chaotropic substance in the solution for extraction and purification of nucleic acid is not particularly limited, and it is preferably 1 mol/L-10 mol/L. As the solution for extraction and purification of nucleic acid, one containing, besides the above-mentioned chaotropic substance, for example, EDTA (ethylenediamine tetraacetic acid), tris-hydrochloride buffer, Triton-X100 and the like is preferably used. A solution for extraction and purification of nucleic acid may be mixed in advance with a liquid sample or magnetically responsive particles before placed in the above-mentioned compartment, or a solution for extraction and purification of nucleic acid may be added after adding magnetically responsive particles and a liquid sample into the compartment.

In step (b), a method for supplying a reagent to the compartment in step (b) is not particularly limited. For example, a reagent feed opening 18 may be inserted in a reagent inlet 10 of chip 2 using the aforementioned reagent cartridge 15, and the reagent 16 may be supplied to the compartment (FIG. 3 (a)).

In step (c) in the method of the present invention, the magnetically responsive particle comprising the biological component adsorbed thereto is separated from the liquid sample. By this step, the magnetically responsive particle and the biological component adsorbed to the magnetically responsive particles in the above-mentioned step (b) (hereinafter sometimes to be referred to as “magnetically responsive particle-biological component composite”) are isolated from the liquid sample, and ultimately, the biological component is separated from the liquid sample. Specifically, step (c) is performed by applying a magnetic field to magnetically responsive particle and moving the magnetically responsive particle-biological component composite from compartments 5 through flow passages 6. In step (c), conventionally known appropriate magnets such as permanent magnet, electromagnet and the like, which provide magnetic field sufficient to energize magnetically responsive particles and move magnetically responsive particle-biological component composite from the compartment 5, can be used on demand as a magnetic field source (e.g., the aforementioned magnet driving device 19). Preferably, a magnet having a magnetic flux density of 500 gauss 4000 gauss, particularly 3000 gauss, is used.

As mentioned above, the device for separating a biological component of the present invention employs a constitution wherein a magnetically responsive particle is used as a carrier of a biological component, and the biological component is stirred, separated and transferred by controlling the magnetic field, which in turn enables reduction of the number of steps involving use of pipette that causes scaling up of an apparatus, thus contributing to the downscaling of the apparatus.

As mentioned above, the device 1 for separating a biological component of the present invention comprises a groove 4 that preferably includes a compartment 5 and a flow passage 6 communicating with the compartment. By controlling the magnetic field in step (c), the above-mentioned magnetically responsive particle-biological component composite moves from compartment 5 to flow passage 6, and the biological component can be separated from the liquid sample.

In the device 1 for separating a biological component as shown in FIG. 1, any of the multiple compartments 5 can be used as a compartment to perform the above-mentioned step (b) (hereinafter the compartment to be used for this purpose is sometimes to be referred to as a “reaction chamber”), and any of the flow passages 6 that communicates this reaction chamber with the adjacent compartment can be used as a flow passage to perform the above-mentioned step (c) (hereinafter the flow passage to be used for this purpose is sometimes to be referred to as a “flow passage for separation”).

In step (d) in the method of the present invention, a biological component and a magnetically responsive particle-biological component composite are separated from each other by liberating the biological component from the composite separated from the above-mentioned liquid sample. As a method therefor, a method comprising elution of the biological component by placing the magnetically responsive particle-biological component composite in an appropriate solvent, or a method comprising separation of the biological component from the magnetically responsive particle by applying an electric field to the magnetically responsive particle-biological component composite can be employed. The conditions under which to apply an electric field are preferably mild ones that do not impair properties of the biological component and magnetically responsive particle, where application of a voltage of 10 V-200 V is preferable. The electric field can be applied using a conventionally known power supply, an electrophoresis apparatus and the like. The processing of step (d) where an electric field is used can be performed in any of the flow passages including the above-mentioned passage for separation (e.g., any of flow passages 6 in the embodiment shown in FIG. 1).

When a nucleic acid is to be extracted using the device 1 for separating a biological component of the present invention, for example, an electrolyte solution is previously injected into a flow passage, a magnetically responsive particle-nucleic acid composite is added thereto and a voltage of about 10 V-200 V is applied. As a result, the nucleic acid alone can be transferred to a positive electrode, thereby separating the magnetically responsive particle from the nucleic acid, and a purified nucleic acid can be obtained. Alternatively, a gel matrix immersed in an electrolyte solution is previously placed in a flow passage, a magnetically responsive particle-nucleic acid composite is added thereto, and a voltage of about 10 V-200 V is applied to the gel matrix. In this way, the magnetically responsive particle does not move into the gel matrix, but the nucleic acid alone moves in the positive electrode direction. Consequently, the magnetically responsive particle is separated from the nucleic acid to produce a purified nucleic acid.

Utilizing an electric field in this manner, a biological component can be liberated from a magnetically responsive particle in a high yield, unlike simple elution with water or buffer, thus contributing to the realization of a microanalysis.

As the above-mentioned electrolyte solution, any conventionally known composition can be used without any particular limitation. Specifically, TAE (tris/acetic acid/EDTA), TBE (tris/boric acid/EDTA) and the like can be mentioned. As the gel matrix, moreover, conventionally known ones can be used without any particular limitation. For example, polyacrylamide, agarose and the like can be mentioned.

For separation of a biological component from a magnetically responsive particle using an electric field in step (d), a membrane having suitable pores can also be utilized. To be specific, a solution containing a magnetically responsive particle-biological component composite is covered with a membrane in a flow passage, a suitable voltage (10-200 V) is applied to liberate the biological component from the magnetically responsive particle, and a purified biological component can be recovered. As the membrane, an appropriate one conventionally used widely in this field can be used without any particular limitation. For example, a membrane made of cellulose, ceramic, polysulfone, cellulose acetate and the like can be mentioned. A membrane having a smaller pore size than does the above-mentioned magnetically responsive particle is preferably used.

As the solution containing the above-mentioned magnetically responsive particle-biological component composite, for example, one obtained by dispersing a magnetically responsive particle-biological component composite in a dispersion medium such as TAE (tris/acetic acid/EDTA), TBE (tris/boric acid/EDTA) and the like is preferably used.

The magnetically responsive particle-biological component composite may be transferred to a flow passage used for the processing in the aforementioned step (d), by controlling the magnetic field in step (c). Alternatively, the magnetically responsive particle-biological component composite separated from the liquid sample in the above-mentioned step (c) may be separated by pipetting and the like and dispensed to a flow passage used for the processing in step (d), and the like. The magnetically responsive particle-biological component composite separated from the liquid sample in the above-mentioned step (c) may be transferred to a different region (e.g., in the embodiment of FIG. 1, any compartment 2 other than the one used as a reaction chamber) by pipetting and the like, the aforementioned magnetically responsive particle-biological component composite is washed several times with a solution having a composition and concentration that do not cause release of a biological component from a magnetically responsive particle, and subjected to the processing in the above-mentioned step (d). As a result, preferable achievement may be obtained in improving the purity of a purified biological component or release of a biological component from a magnetically responsive particle.

The device 1 for separating a biological component of the present invention may have one or more regions to contain a biological component separated from a magnetically responsive particle in the above-mentioned step (d) (hereinafter this region is to be referred to as a “recovery chamber”). The presence of such recovery chamber enables preservation of a biological component after processing in the above-mentioned step (d) until application thereof to a subsequent processing (e.g., analysis of nucleic acid or protein and the like) by an appropriate means. The size of the recovery chamber is not particularly limited. When multiple chambers are present, they may have the same size or different sizes, with preference given to approximately the same size as that of the aforementioned reaction chamber. The recovery chambers may or may not be communicated with the aforementioned reaction chambers via flow passages (could be passages for separation). In the device 1 for separating a biological component as shown in FIG. 1, at least any of the above-mentioned multiple compartments 5, except the one used as a reaction chamber, can be used as a recovery chamber.

The device 1 for separating a biological component of the present invention may be constituted to simultaneously perform multiple steps, for example, simultaneously processing two or more liquid samples, processing a single liquid sample in two or more portions and the like. Examples of this constitution include one comprising multiple compartments and flow passages communicating these, which are formed in multiple steps in the first width direction X or the second width direction Y and the like. In this case, a divider may be set in the flow passage to distinguish compartments 5 and flow passages 6 used for each sample from those used for other sample. For transfer of a liquid sample, it is not necessary to use a magnetic field or an electric field for every transfer, and a known means such as pipetting and the like may be employed in some cases. For example, when the aforementioned recovery chambers are communicated with the reaction chambers via flow passages, an electric field can be used to transfer a biological component to recovery chambers, and when the recovery chambers and reaction chambers are not communicated with each other, pipetting may be used to separate and dispense a biological component, which has been separated from a magnetically responsive particle in step (d), to recovery chambers.

According to the method of separating a biological component of the present invention comprising the following steps (a)-(d), a biological component in a liquid sample can be efficiently separated (extracted, purified) by a convenient operation, and a microscale system for separating a biological component, which has been difficult by conventional techniques, can be constructed.

When the biological component is a nucleic acid in the present invention, moreover, the separated nucleic acid may be further amplified in compartments after the above-mentioned steps (a)-(d). When such amplification processing is to be performed, groove 4 may have a compartment in which to perform PCR (hereinafter to be referred to as an “amplification chamber”), whereby a conventionally known method capable of amplifying nucleic acid, such as PCR and the like, is realized. On this occasion, it is preferable to combine the device of the present invention with a temperature control means (not shown) capable of adjusting the inside of the amplification chamber to a temperature cycle preferable for performing PCR. The size of the amplification chamber is not particularly limited, and may have approximately the same size as that of the aforementioned reaction chamber and recovery chamber. When multiple amplification chambers are present, the respective chambers 5 may be of the same size or different sizes. The temperature control means may be any as long as it can control the inside of the amplification chamber to a temperature cycle preferable for performing PCR, and a temperature control means used for conventionally known PCR apparatuses can be mentioned. Of these, a temperature control means using a peltier element is preferable, since it can markedly improve the reaction efficiency.

As a means for transferring a nucleic acid separated from a liquid sample to an amplification chamber, an electric field can be mentioned, and where necessary, pipetting can also be mentioned. The polymerase, substrate, primer, buffer and the like necessary for PCR can be injected in advance into an amplification chamber as reagents, or dispensed to amplification chambers by pipetting.

The nucleic acid separated from a liquid sample may be amplified in the compartments used as recovery chambers, without transferring therefrom.

The device for separating a biological component of the present invention may be used in combination with a control means capable of automatically controlling at least one of the respective steps (preferably, capable of automatically controlling all steps). A combined use with such control means also enables automatic operation of a part or the whole of the steps for separation (extraction, purification) of a biological component. The control means comprises a control device that controls on/off of a driving source used for a step to be controlled, level of action, state of action and the like. It is also possible to combine the aforementioned control device with, for example, control equipment necessary for controlling action in each of the above-mentioned steps, such as a control circuit including a control computer having control programs, a sequential control circuit and the like. Moreover, a driver necessary for directly transmitting drive signals to the driving source in each of the above-mentioned steps, a sensor necessary for detecting the state of action of the driving source in each of the above-mentioned steps, a switch and the like may be added as appropriate.

While the focus of the aforementioned explanation was separation (extraction, purification) of DNA, the method of separating a biological component of the present invention can be similarly applied to RNA, protein and the like.

### INDUSTRIAL APPLICABILITY

According to the present invention, separation (extraction, purification) of a biological component such as nucleic acid, protein and the like, which has been difficult by conventional techniques, can be conveniently and efficiently performed. This enables realization of a series of steps relating to the separation of the aforementioned biological components on a microscale, which can be used in the diagnosis field. Moreover, a total downscale system from separation (extraction, purification) to analysis of biological components, i.e., micro-TAS (total analysis system) can be provided.

This application is based on a patent application No. 2003-197937 filed in Japan, the contents of which are hereby incorporated by reference.

1. A device for separating a biological component, which comprises magnetically responsive particles and a chip obtained by adhering a pair of substrates, which comprise one or multiple grooves formed on at least one surface thereof, with the groove(s) placed inside.

2. The device of claim 1, wherein said groove forms, within the chip, at least one compartment and a flow passage communicating with the compartment.

3. The device of claim 2, wherein said groove has a protrusion protruding into the compartment.

4. The device of claim 1, wherein the biological component is a nucleic acid.

5. The device of claim 4, wherein the magnetically responsive particles further comprise silica.

6. A method of separating a biological component from a liquid sample comprising the biological component, which uses a device of claim 1, and comprises the following steps (a)-(d):
(a) a step of holding the device such that the adhesion surface of the pair of substrates is about perpendicular to the horizontal direction,
(b) a step of adsorbing the biological component to magnetically responsive particles by contacting the magnetically responsive particles with the liquid sample containing the biological component,
(c) a step of separating the magnetically responsive particles comprising the biological component adsorbed thereto from the liquid sample, and
(d) a step of separating the biological component from the magnetically responsive particles.

7. The method of claim 6, wherein the magnetically responsive particles comprise ferromagnetic particles.

8. The method of claim 6, wherein the step (c) is performed by moving the magnetically responsive particles by application of a magnetic field.

9. The method of claim 6, wherein the step (d) is performed by dissolving the biological component in a solvent.

10. The method of claim 6, wherein the step (d) comprises a step of separating the biological component from the magnetically responsive particles by applying an electric field.

11. The method of claim 6, wherein at least one of the steps is automatically controlled.

12. The method of claim 6, wherein the biological component is a nucleic acid.

13. The method of claim 12, wherein the magnetically responsive particles further comprise silica.
